(19) United States
(12) Patent Application Publication
(10) Pub. No.: US 2022/0333475 A1
(43) Pub. Date: Oct. 20, 2022

(54) Method and System for Separating Oil Well Substances With Means for Capturing and Removing Liquid From a Gas Outlet Pipeline

(71) Applicant: Seabed Separation AS, Porsgrunn (NO)

(72) Inventors: Jon Sigurd Berntsen, Porsgrunn (NO); Asle Jostein Hovda, Jakobsli (NO)

(21) Appl. No.: 17/765,026

(22) PCT Filed: Oct. 13, 2020
(86) PCT No.: PCT/NO2020/050249

§ 371 Date: Mar. 30, 2022

(30) Foreign Application Priority Data
Oct. 15, 2019 (NO) 20191230

(51) Int. Cl. E21B 43/36; E21B 43/34; B01D 17/02; B01D 19/00

(52) U.S. Cl. CPC E21B 43/36; E21B 43/35; B01D 17/0214; B01D 19/0042

(57) ABSTRACT

A method and system for separating oil well substances provided with means for capturing liquid in separated gas for preventing liquid carry over in separated gas as well as providing a liquid lock preventing gas carry over.

### BACKGROUND

The disclosed embodiments are related to a method for separating oil well substances and also related to a system for separating oil well substances.

More particularly, the embodiments are related to a method and system for separating oil well substances wherein liquid carry over in separated gas is avoided.

Fluids being produced from oil wells may comprise a mixture of fluid and solid components like oil, water, gas and sand, which are commonly referred to as fluid and solid phases, where the percentage fraction of each respective component may vary from one oil field to another, and also during the operational lifetime of the same oil well. It is for example common to have an increase in water content from oil wells towards the end of the production life time of the oil wells. Separation of fluid components may be necessary to be able to accomplish further processing of the oil and gas in a refinery for example. However, the requirement of further separation is not always a demand. Sometimes there is a demand for very clean oil with a very low water content, while in other cases some water in the produced oil, for instance 1% to 5% may be tolerated.

From EP2981341—METHOD FOR SEPARATING SUBSTANCES MIXED IN FLUIDS FROM OIL WELLS and EP2934714—INCLINED TUBULAR SEPARATOR FOR SEPARATING OIL WELL SUBSTANCES, both in the name of the applicant, is known an inclined tubular separator, system and method for providing separation of respective fluid components mixed in fluids from oil wells.

In WO2006118468 it is described a pipe separator for separation of a fluid, in particular separation of fluids with non-mixable fluid components such as oil, gas and water, comprising an extended tubular separator body with a diameter that is principally the same as or slightly larger than the diameter of the inlet pipe and the outlet pipe(s) for the separated components from the separator.

From WO 2006098637 A1 it is known a device in connection with a pipe separator, comprising an extended tubular body with a diameter that is principally the same as or slightly larger than the diameter of the inlet pipe/outlet pipe of the separator. A separate gas manifold is arranged in connection with the inlet. The manifold comprises a number of vertical degassing pipes, which are connected to the inlet pipe immediately ahead of the inlet to the separator and which end in an overlying, preferably slightly inclined gas collection pipe. The gas is designed to be diverted up through the vertical degassing pipes and collected in the gas collection pipe for return to the outlet pipe after the separator or transport onwards to a gas tank or gas processing plant or similar.

In WO2004016907 A1 it is described a pipe separator for the separation of fluids, for example separation of oil, gas and water in connection with the extraction and production of oil and gas from formations beneath the sea bed, comprising a pipe-shaped separator body with an inlet and outlet that principally corresponds to the transport pipe to which the pipe separator is connected. The special feature of this solution is that a pipe bend or loop is arranged in the pipe separator or in connection with its outlet to form a downstream fluid seal in relation to the pipe separator, which is designed to maintain a fluid level in the pipe separator, but which also allows the pipe separator and the loop to be pigged.

From NO341580 B1, in the name of the applicant, is known a method and system for separating oil well substances by using a separator system comprising inclined tubular oil and water separators for separating the respective fluid components mixed in fluids from oil wells, combined with providing a liquid lock upstream the inclined tubular oil and water separators, as well as establishing and maintaining water-wetted entrance to the inclined tubular oil and water separators.

It is known in the oil and gas industry that liquids transported in the gas pipeline can cause various problems and as a guideline to such the so-called, liquid carry over, from a separator or scrubber shall not exceed defined limits as tabulated in Table 1.

TABLE 1
Typical parameters used in the oil and gas industry.

| | Value | |
|---|---|---|
| Parameter | SI | FPS |
| Liquid content of separated gas | 0.013 to 0.067 m³ | 0.1 to 0.5 gal per |
| | per 10⁶ std m³ | MMscf |
| Gas content of separated liquid | <1% volume/ | <1% volume/ |
| | volume | volume |

| | |
|---|---|
| Target separable gas bubble size | 200-300 microns |
| Slug handling capacity | Application Specific |

If the separation of liquids from gas take place in a subsea system, it is strongly recommended to focus on removal of the water. The reason is related to forming of gas hydrates if the volume of water in the pipeline is exposed to a depressurisation and temperature reduction. Oil carry over in the further transportation of gas will not have the same consequence as a water carry over (no hydrates).

A typical operation, to avoid creation of hydrates, is continuous injection of glycol (MEG), an operation that is both costly and requires a new separation/recovery process at gas arrival location.

In the last years, it is documented that most liquids carried by the gas is not transported as droplets in the gas, but as a liquid film that “creeps” in the pipe wall. Offshore tests have shown that at as high gas velocity as 25 m/s the volume of droplets in the gas was only few ppm (test: sampling in the centre of the pipe) while the liquid carry over was determined to be several % vol of oil and water (test: Flush with pipe wall).

It is thus a need for a method and system for preventing liquid carry over (creeping liquid film) in separated gas in the gas outlet pipeline and removal of the captured liquid.

Further, an important parameter in systems like this is liquid level interaction between slug suppression and gas removal units and oil and water separator system to avoid free gas carry between units.

There is an increased demand of more efficient separation process, scalable and adaptable separator system, as well as compact systems with long lifetime.

There are also increasing demands that separation system and associated equipment should be capable of meeting requirements for effective and long transport of fluids by removal of all water avoiding increase in viscosity due to emulsification as well as providing an opportunity to transport the gas as a separate phase. Separate transport of gas will minimize or eliminate slug flow, which typically represents a problem if comingled with the oil after the separation of water.

Hence, a method and system for improved separation of oil well substances would be advantageous, and in particular, a more efficient and/or configurable and adaptable method and system would be advantageous.

### SUMMARY

Provided herein is a method and system for separating oil well substances partly or entirely solving the above-mentioned drawbacks of prior art and present demands.

Also provided is a method and system for separating oil well substances providing enhanced separation of oil and gas from water.

Also provided is a method and system for separating oil well substances providing prevention of liquid carry over in separated gas.

Also provided is a method and system for separating oil well substances providing capturing of liquid in a gas outlet pipeline and removal of the captured liquid from the gas outlet pipeline.

Also provided is a method and system for separating oil well substances providing capturing of creeping liquid film in a gas outlet pipeline.

Also provided is a method and system for separating oil well substances wherein adding the captured liquid from the gas outlet pipeline to an inclined separator system for separation.

The disclosed method and system further provide for separating oil well substances solving the problem of liquid level interaction between slug suppression and gas removal unit(s) on the one side, and the oil and water separator system on the other side, to avoid free gas carry between units.

Also provided is a method and system for separating oil well substances avoiding free gas carry under between the slug suppression and gas removal unit(s) and the inclined oil and water separator system by providing and maintaining a liquid lock upstream the inclined oil and water separator system.

Also provided is a method and system for separating oil well substances promoting separation of oil and water prior to entering an inclined oil and water separation system.

Also provided is a method and system for separating oil well substances providing a “boosting” of the separation of the dispersion band between oil and water.

Also provided is a method and system for separating oil well substances providing a velocity difference between different phases, hence promoting efficient separation by reducing the thickness of the dispersion band present between oil and water.

Provided herein is a method and system for improvement of the use slug suppression and gas removal units 100 in combination with an oil and water separation system. The embodiments further take basis in that a slug suppression and gas removal unit (SSGR unit) is arranged between a well and the inclined oil and water separator system. The disclosed embodiments relate to improvement of the methods and systems for separating oil and well substances described in in EP2981341, EP2934714 and NO341580 B1, all in the name of the applicant, the content of both included herein by reference.

According to the disclosure, the method and system make use of an apparatus for capturing liquid in gas outlet pipeline of the slug suppression and gas removal units and removal of the captured liquid from the gas outlet pipeline, and thus from the separated gas, such that there is no liquid carry over in the separated gas.

In accordance with a further embodiment the apparatus for capturing liquid in the gas outlet pipeline is a helical liquid collector arranged interior the gas outlet pipeline, which helical liquid collector is arranged for capturing creeping liquid film in the gas outlet pipeline.

According to a further embodiment the captured liquid from the gas outlet pipeline is removed from the gas outlet pipeline via a mainly vertically extending drainpipe and added to a large diameter pipeline extending mainly horizontally from the slug suppression and gas removal unit to the inclined oil and water separator system for being processed/separated by the inclined oil and water separator system.

A further embodiment comprises avoiding free gas carry under between the slug suppression and gas removal unit and the inclined oil and water separator system, as well as the vertically extending drainpipe, by providing a liquid lock.

A further embodiment comprises providing and maintaining the liquid lock by arranging liquid level interaction between the slug suppression and gas removal unit and inclined oil and water separator system, as well as the mainly vertically extending drainpipe, close to equal height.

According to a further embodiment, the inclined oil and water separator system comprises multiple inclined tubular separators comprising:
an elongated outer tube and an elongated inner tube, where the inner tubular tube is arranged inside the outer tube,
where oil well substances are introduced into an end of the inner tube via a feed section passing through the outer tube and into the inner tube,
and where the inner tube comprises multiple holes or slots arranged in a longitudinal direction,
where the inclination of the tubular separator facilitates separation of the oil well substances into lower density substances and higher density substances.

In the inclined tubular separators, lower density substances by buoyancy drift upwards through the slots or holes and exit via an upper outlet in the outer tube, and higher density substances sink downwards through the slots or holes and by gravitation exit via a lower outlet in the outer tube.

According to disclosure, a liquid lock is provided and maintained that avoids free gas carry under between the SSGR unit and the inclined oil and water separator system, as well as the vertically extending drainpipe. According to an embodiment this is achieved by that a large diameter horizontal pipeline is arranged upstream of the inclined oil and water separator system, i.e. between the SSGR unit and the inclined oil and water separator system, for transporting fluids to the inclined oil and water separator system. According to a further embodiment this is achieved by arranging a suitable construction for this function, upstream the inclined oil and water separator system, or a downstream unit of the SSGR unit utilizing the elevation difference for slug suppression.

According to a further aspect of the disclosure, separation of oil and water is promoted prior to entering the inclined oil and water separator system by using the horizontal large diameter pipeline between the SSGR unit and the inclined oil and water separator system, hereunder also the added captured liquid (oil and water) from the drainpipe.

In a further aspect, an interface between oil and water in the inclined tubular oil and water separator is arranged at approximately 50-70% of the overall length (L), referred to inlet end of the inclined tubular oil and water separator.

According to a further aspect, the location of the first hole or slots in the inner tube, referred to the inlet end of the inclined tubular oil and water separator, especially at the water side, is located approximately ⅓ of the overall length (L) of the inclined tubular oil and water separator.

According to a further aspect, the location of the first hole or slots, the number of holes or slots and/or the size of the holes or slots, in the inner tube may be different at the oil side (upper side) compared to the water side (lower side).

In a further aspect, an oil-wetted zone is established in the inclined tubular oil and water separator.

According to a further aspect, a velocity difference is established between oil and water, where the oil velocity is increased and a thinner dispersion band (sedimentation distance) is achieved. The result is an improved coalescence, following a reduced distance for water droplets to form and to grow and finally to move towards the interface between oil and water. The liquid velocity in the large diameter pipeline is used as an ejector for captured liquid and for maintaining the liquid level in the vertically extending drainpipe.

The location of the holes or slots and the location of the interface between oil and water will provide an oil and water separator system where the lower part of the oil and water separator is always maintained water-wetted.

The design of the holes and slots and control of the location of the interphase between oil and water further ensures that the lower part of the inclined oil and water separator system will be water-wetted even in the cases where pure oil with little dispersed water enters the inclined oil and water separator system.

Further preferable features and advantageous details of the disclosed embodiments will appear from considering the following example description, claims and attached drawings.

### BRIEF DESCRIPTION OF THE DRAWINGS

The present invention will below be described in further detail with references to the attached drawings, where:

FIG. 1 is a principle drawing of an inclined separator system according to prior art,

FIG. 2 is principle drawing showing the interior of an inclined tubular separator of the inclined separator system in FIG. 1,

FIG. 3 is a principle drawing of an inclined oil and water separator system according to prior art,

FIG. 4 is a principle drawing of a system according to the disclosure,

FIG. 5 is a principle drawing of an apparatus for capturing liquid according to the disclosure,

FIG. 6 is a principle drawing of the described effects in a horizontal pipe/pipeline according to prior art, and

FIG. 7 is a principle drawing of an inclined tubular oil and water separator according to prior art showing details of holes or slots, and oil and water interface.

### DETAILED DESCRIPTION

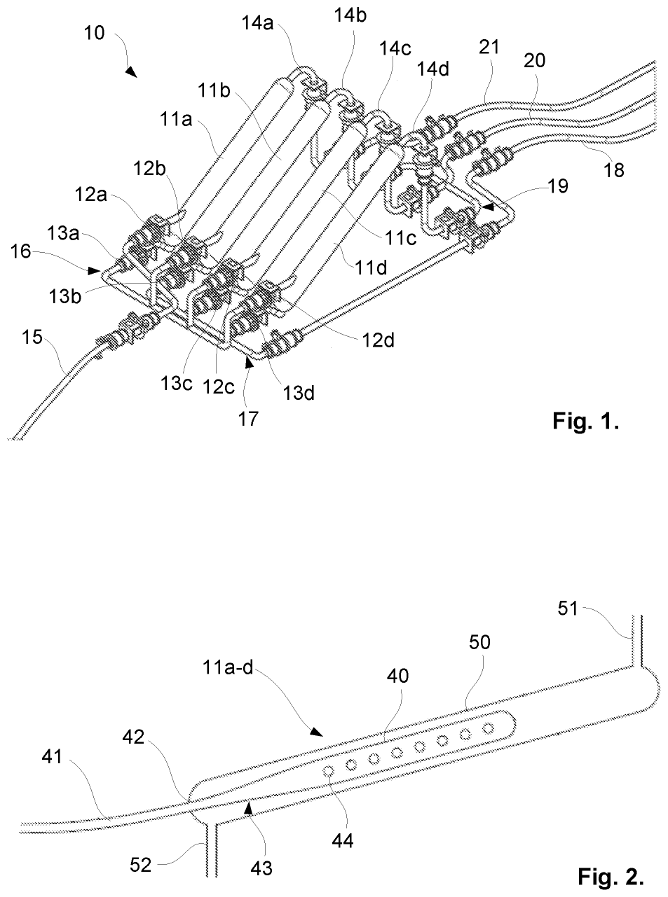

Reference is first made to FIGS. 1 and 2 which are principle drawings of a separator system according to prior art, as described in EP2981341 and EP2934714, both in the name of the applicant, the disclosure of this incorporated herein by reference, illustrated by a separator system comprising four interconnected inclined tubular separators 11a-d using gravity as the separating force.

Each inclined tubular separator 11a-d has a respective inlet 12a-d in a lower section of the inclined tubular separator 11a-d, and a respective outlet 13a-d also located in the lower/bottom section of the inclined tubular separator 11a-d. A respective outlet 14a-d is located in an upper section of the inclined tubular separator 11a-d.

The separator system is supplied with fluid from an oil well (not shown) by a pipe 15 and via an input manifold 16 which distributes the fluid to the respective inclined tubular separators 11a-d and interconnecting the inclined tubular separators 11a-d in a parallel fashion, or in series, or in a combination of parallel and serial configurations. There is further arranged a first output manifold section 17 interconnecting the outlets 13a-d in a parallel fashion, or in series, or in a combination of parallel and serial configurations to an outlet pipe 18.

There is further arranged a second output manifold section 19 interconnecting the outlets 14a-d from the inclined tubular separators 11a-d, in a parallel fashion, or in series, or in a combination of parallel and serial configurations to an outlet pipe 20, with respect to the number of phases the separator system is adapted and manufactured to separate.

In this illustrated example, three of the inclined tubular separators 11b-d are interconnected such that the three outlet openings 14b-d of these in the upper section of the inclined separator system from the three respective tubular separators 11b-d are connected together to a common outlet pipe 20, while one outlet 14a in the upper section from a fourth inclined tubular separator 11a is connected to an outlet pipe 21.

The lower outlet 12b-d of the inclined tubular separators 11b-d are connected together to the outlet pipe 18, while the lower outlet 12a of the inclined tubular separators 11a is connected to the respective inlets 12a-d of the inclined tubular separators 11b-d.

The fluid streaming through the pipe 15 passes a first tubular separator 11a wherein the gas is separated from the fluid because the density of the gas is lower than other fluid phases present in the incoming fluid. The gas phase is transported out through the outlet 14a in the upper section of the inclined tubular separator 14 to the outlet pipe 21.

The outlet 13a of the first inclined tubular separator 14a is connected in parallel to inlets 12b-d of the respective inclined tubular separators 11b-d thereby providing a sufficient separator capacity for separating oil from water and sand, for example. The oil phase is transported out of the separator system via the respective outlets 14b-d of the respective inclined separators 11b-d, and in the output manifold section 19 these outlets are connected together and are connected to the outlet pipe 20 of the separator system. The water and sand phase is transported out of each respective inclined tubular separators 14b-d being configured to separate oil from water and sand via the outlets 13b-d being located in the bottom section of the inclined separator system first outlet manifold 17 an to the outlet pipe 18.

The interconnection pattern provided for with pipe connections in the input manifold section 17, is reflected in the output manifold section 19. The pattern of interconnecting pipes reflects the properties of the incoming fluids from an oil well, while the interconnection pattern in the output manifold section 19 reflects how many fluid phases that are to be separated and how different fluid phases will still be combined. Therefore, there is a functional relationship between the interconnecting pattern of pipes in the input manifold section 17 and the output manifold section 19, but not necessary as a one to one mapping of the configuration of the respective pipes in each respective manifold section.

Reference is now made to FIG. 2, showing details of the interior of the inclined tubular separators 11a-d. The inclined tubular separators 11a-d have an inner elongated tube 40 located centred inside an outer elongated tube 50, wherein the inner tube 40 is in fluid communication with the input manifold 17 or pipe 15 via the respective inlets 12a-d and via a curved pipe 41 extending out of the outer tube 50 via an opening 42 in a side wall of the outer tube 50 at a lower section of the inclined tubular separator 11a-d. The inner tube 40 exhibits a conical shaped part 43 at the lower/inlet part thereof expanding in width from the curved pipe 41 to a final width of the inner tube 40. The walls of the inner tube 40 are further perforated with a plurality of holes or slots 44, and the inner tube 40 is terminated and closed at upper end thereof. The outer tube 50 has a first outlet opening 51 arranged at upper end thereof connected to the outlet 14a-d and a second outlet opening 52 at lower end thereof connected to the outlet 13a-d. The curved pipe 41 provides a small cyclone effect separating oil and water in two layers before the mixed fluid enters the conical shaped part 43. The conical shape will reduce the speed of the fluid before passing the inner tube holes or slots 44.

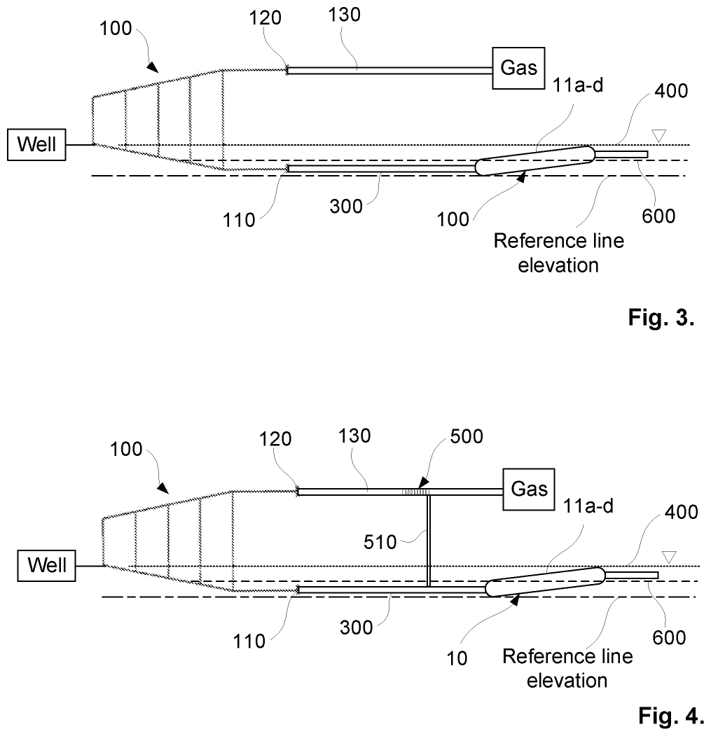

Reference is now made to FIG. 3 which is a principle drawing of a prior art system as disclosed in NO341580 B1, in the name of the applicant, the disclosure of this incorporated herein by reference, illustrating the principle of establishing and maintaining a water-wetted surface. The system establish and maintain a water-wetted inlet pipe surface in conjunction with a slug suppression and gas removal unit 100 (SSGR), horizontal large diameter pipeline 300 and multiple inclined tubular oil and water separators 11a-d, based on the principles described above. E.g. the horizontal large diameter pipeline 300 can have a diameter between 10″ and 20″.

In an inclined oil and water separator system 10 like this, a unit 100 designed to suppress slug flow and remove free gas (SSGR unit), also known as gas harp, will be arranged between a well and the inclined oil and water separator system 10. The inclined oil and water separator system 10 will further be connected to the SSGR unit 100 via a large diameter pipeline 300 extending mainly horizontally from the SSGR unit 100 to the inclined oil and water separator system 10.

Oil and water outlet 110 of the production SSGR 100 is connected to the inclined tubular separator system 10, via the input manifold section 16, by the horizontal large diameter pipeline 300. The production SSGR 100 will further provide a gas output 120 for gas export via a gas outlet pipeline 130. The gas outlet pipeline 130 may also be connected to an oil and gas output of the inclined separator system 10, which is well known for a skilled person and requires no further description herein.

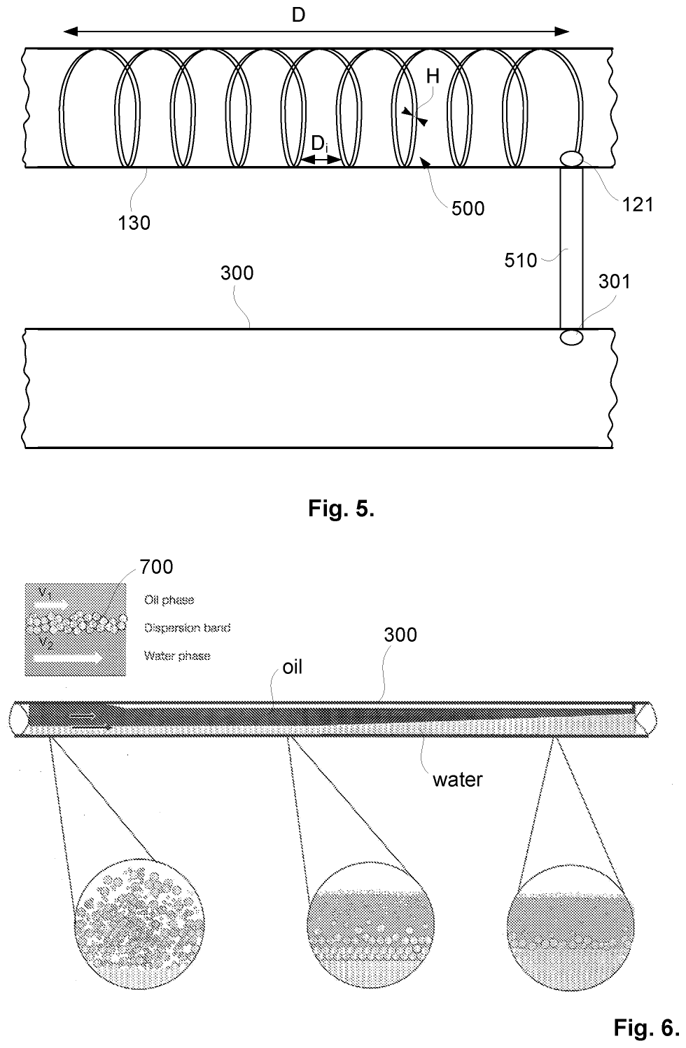

Reference is now made to FIGS. 4-5 which are a principle drawing of an embodiment of a system for separating oil well substances. The system further comprises an apparatus 500 for capturing liquid arranged interior in the gas outlet pipeline 130 from the slug and gas removal unit 100 capturing liquid in the gas outlet pipeline 130, and thus liquid in the separated gas from the slug suppression and gas removal unit 100.

According to one embodiment the apparatus 500 is formed by a helical liquid collector adapted for capturing creeping liquid film in the gas outlet pipeline 130.

The system further comprises a vertically extending drainpipe 510 extending between the gas outlet pipeline 130 and the horizontal large diameter pipeline 300, which vertically extending drainpipe 510 is aligned with corresponding openings 121, 301 in lower part of the gas outlet pipeline 130 and upper part of the horizontal large diameter pipeline 300, respectively.

The helical liquid collector 500 extends in longitudinal direction of the gas outlet pipeline 130 and ends in the opening 121 of the lower part of the gas outlet pipeline 130, as shown in FIG. 5.

The helical liquid collector 500 is fixed, e.g. by welding, to interior surface of the gas outlet pipeline 130, and extends a distance D in longitudinal direction of the gas outlet pipeline 130. The distance D will typically be minimum 1.5× pipeline diameter and maximum 3× pipeline diameter. There will preferably be a distance Di in the range 1-3× pipeline diameter, more preferably approximately 1.5× pipeline diameter, between each turn of the helical liquid collector 500. Pipeline diameter referred to above is the diameter of the gas outlet pipeline 130.

The helical liquid collector 500 is protruding interior in the gas outlet pipeline 130 with a height H from the interior surface of the gas outlet pipeline 130. The height H will e.g. be at least 1 cm, but not higher than 2 cm, such that it will not restrict the flow of gas in the gas outlet pipeline 130.

According to an embodiment the helical liquid collector 500 extends at least 360 degrees, more preferably in the range 500-600 degrees, in circumferential direction of the gas outlet pipeline 130 over the distance D.

An important parameter when combined with an inclined oil and water separator system 10 is the liquid level 400 interaction between the SSGR unit 100 and the inclined tubular oil and water separators 11a-d of the inclined oil and water separator system 10, as well as the drainpipe 510. This liquid level 400 shall be close to equal height providing a liquid lock avoiding free gas carry under between the units. Associated gas (dispersed in the liquids) will be transported in the large diameter pipeline 300, but further gas release will be minimal and not interfere with the operation or function of the inclined oil and water separator system 10.

This liquid lock can also be arranged in other ways, such as e.g. by using a gas harp, as well known in prior art, e.g. WO 2006/098637, upstream the inclined oil and water separators 11a-d, where the gas harp will function as a Slug Suppressor Gas Removal (SSGR) unit 100.

Downstream the SSGR unit 100 the fluids will be transported in the large diameter pipeline 300 entering the inclined oil and water separators 11a-d of the inclined oil and water separator system 10. The liquid level (elevation) 400 of the SSGR unit 100 located at a slope part of the gas Harp/SSGR unit 100, at the top of inclined oil and water separators 11a-d and in lower part of the drainpipe 510 will provide and maintain the liquid lock upstream the inclined tubular oil and water separators 11a-d preventing gas carry under.

Accordingly, the liquid level 400 in the drainpipe 510 will function as a gas lock avoiding gas carry under into the large diameter pipeline 300.

As mentioned, the inclined oil and water separator system 10 will preferably consist of multiple inclined tubular oil and water separators 11a-d, as described above, the number of inclined tubular oil and water separators 11a-d will depend on the flow rate and separability of oil/water.

In FIG. 6 is schematically the principle of promoting separation of oil and water prior to entering the inclined oil and water separator system 10 by a longitudinal cross-sectional view of the large diameter pipeline 300, with exploded views showing details. Along the extension of the large diameter pipeline 300 separation between water and oil occurs due to gravity forces. Along the extension of the large diameter pipe 300 this will result in increased oil velocity and dispersion band 700 which make the sedimentation distance for water droplets in oil to move towards the interface between oil and water shorter. This increase of velocity difference between oil and water will enhance separation by breaking the dispersion band 700.

Further, the embodiments use the liquid velocity in the large diameter pipeline 300 as an ejector for captured liquid and maintaining the liquid level in the vertically extending drainpipe 510.

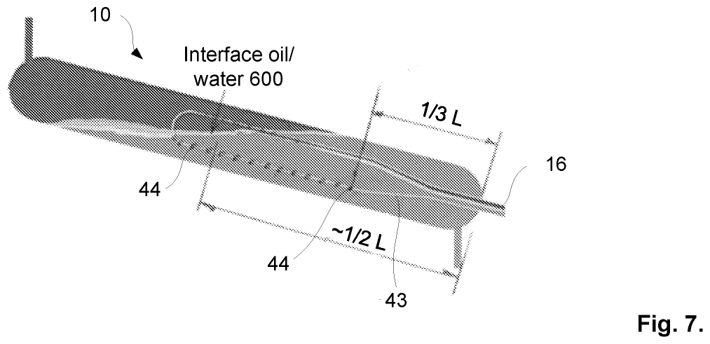

The inner tube 40 further also includes perforations in the form of holes or slots 44. The location of the holes or slots 44 and the interface 600 between oil and water in the inclined tubular separator 11a-d, provide an oil and water separator system that establish and maintain a lower part that is always water-wetted, as shown in FIG. 7.

Further, the location of the first hole or slot 44, referred to inlet end of the inclined tubular oil and water separator 11a-d, at least at the waterside, start approx. ⅓ of the overall length L of the inclined tubular oil and water separator 11a-d, i.e. after the conical part 43.

It should be mentioned that the number and size of holes or slots 44 at the oil and water side, respectively, can be different. Also the location of the first hole or slot 44 on the oil side (upper side) can be further from the inlet end of the inclined tubular oil and water separator 11a-d than the first hole or slot 11a-d at the water side (the lower side).

The interface 600 between oil and water is located at approx. 50-70% of the overall length L of the inclined tubular oil and water separator 11a-d, referred to inlet end of the inclined tubular oil and water separator 11a-d. This combination, location of holes or slots 44, and oil/water interface 600, secures a constant presence of water in the lower part of the inclined tubular oil and water separator 11a-d. Achieved by this is improved coalescence, hence better separation of oil and water.

In the disclosed embodiments, where the inner tube 40 has a slot or hole 44 located at a position ⅓ L, at least at the water side, from inlet of the inclined tubular oil and water separator 11a-d, and an interphase between oil and water at 50-70% of the overall length L from inlet of the inclined tubular oil and water separator 11a-d, ensures that the inlet of the inclined tubular oil and water separators 11a-d will be water-wetted even in the cases where pure oil with little dispersed water enters the separator system. This water lock function will always create the velocity difference between the phases (oil and water); hence promote separation by reducing the dispersion band 700 normally present between oil and water.

Accordingly, the inventive embodiments provide an inlet arrangement for an oil and water separator system designed to prevent liquid carry over in separated gas by capturing and removing liquid from separated gas, as well as establishing and maintaining a water lock preventing gas carry under between the slug suppression and gas removal unit (SSGR) and the inclined oil and water separator system, as well as drainpipe.

1-17. (canceled)

18. A method for separating oil well substances, comprising:
providing a system that includes:
(i) a slug suppression and gas removal unit (100) arranged to a well, and
(ii) an inclined oil and water separator system (10) connect to the slug suppression and gas removal unit (100) via a horizontal pipeline (300),
capturing liquid in a gas outlet pipeline (130) of the slug suppression and gas removal unit (100), and
removing the captured liquid from the gas outlet pipeline (130).

19. The method according to claim 18, comprising using a helical liquid collector (500) interior in the gas outlet pipeline (110) to capture creeping liquid film in the gas outlet pipeline (130).

20. The method according to claim 18, comprising
removing the captured liquid from the gas outlet pipeline (130) via a substantially vertically extending drainpipe (510), and
adding the captured liquid to the horizontal pipeline (300).

21. The method according to claim 18, comprising providing a liquid lock to avoid free gas carry under between the slug suppression and gas removal unit (100) and the inclined oil and water separator system (10).

22. The method according to claim 21, comprising providing and maintaining the liquid lock by arranging liquid level (400) interaction between the slug suppression and gas removal unit (100) and the inclined oil and water separator system (10), and the substantially vertically extending drainpipe (510) proximate an equal height.

23. The method according to claim 22, comprising
using an oil and water separator system (10) with at least two inclined tubular oil and water separators (11a-11d) formed by an elongated outer tube (50);
arranging an elongated inner tube (40) in the elongated outer tube (50), wherein oil well substances are introduced into an end of the inner tube (40) via a feed section passing through the outer tube (50) and into the inner tube (40), and the inner tube (40) comprises multiple holes or slots (44) arranged in a longitudinal direction; and
arranging an interface (600) between oil and water in the respective inclined tubular oil and water separator (11a-11d) at approximately 50-70% of a length (L) of the tubular oil and water separator (11a-11d), the side of the interface defining an inlet end of the respective inclined tubular oil and water separator (11a-11d).

24. The method according to claim 23, comprising arranging the location of the first hole or slots (44) toward the inlet end of the inclined tubular oil and water separator (11a-d) at least at the water side starting at a position approximately ⅓ of the overall length (L) of the inclined tubular oil and water separator (11a-11d).

25. The method according to claim 22, comprising arranging the liquid level (400) at a top of the inclined tubular oil and water separator system (10).

26. The method according to claim 18, comprising using liquid velocity in the large diameter pipeline (300) as an ejector for captured liquid and maintaining the liquid level in the vertically extending drainpipe (510).

27. A system for separating oil well substances, comprising:
a slug suppression and gas removal unit (100) arranged to a well and an inclined oil and water separator system (10); wherein
the slug suppression and gas removal unit (100) is connected to the inclined separator system (10) via a substantially horizontal pipeline (300), and
an apparatus (500) for capturing liquid is arranged interior in a gas outlet pipeline (130) of the slug and gas removal unit (100) for capturing liquid in the gas outlet pipeline (130).

28. The system according to claim 27, wherein the apparatus (500) for capturing liquid is a helical liquid collector adapted for capturing creeping liquid film in the gas outlet pipeline (130).

29. The system according to claim 27, comprising
a substantially vertically extending drainpipe (510) extending between the gas outlet pipeline (130) and the substantially horizontal pipeline (300), the substantially vertically extending drainpipe (510) being aligned with a corresponding opening (121) in a lower part of the gas outlet pipeline (130) and a corresponding opening (301) in an upper part of the horizontal large diameter pipeline (300), wherein
the helical liquid collector (500) ends in the opening (121) of the lower part of the gas outlet pipeline (130).

30. The system according to claim 29, wherein the helical liquid collector (500) is fixed to an interior surface of the gas outlet pipeline (130), extends a distance (D) in a longitudinal direction of the gas outlet pipeline (130) and protrudes interior to the gas outlet pipeline (110) at a height (H) from the interior surface of the gas outlet pipeline (110).

31. The system according to claim 27, wherein the helical liquid collector (500) is fixed to an interior surface of the gas outlet pipeline (130), extends a distance (D) in a longitudinal direction of the gas outlet pipeline (130) and protrudes interior to the gas outlet pipeline (110) at a height (H) from the interior surface of the gas outlet pipeline (110).

32. The system according to claim 30, wherein the helical liquid collector (500) extends at least 360 degrees in a circumferential direction of the gas outlet pipeline (130) over the distance (D).

33. The system according to claim 32, wherein the helical liquid collector (500) extends within a range of 500-600 degrees in a circumferential direction of the gas outlet pipeline (130) over the distance (D).

34. The system according to claim 29, wherein the slug suppression and gas removal unit (100), the inclined oil and water separator system (10) and the vertically extending drainpipe (510) are arranged such that a liquid level (400) interaction between them is at a substantially equal height, thereby providing a liquid lock avoiding free gas carry under between the gas removal unit (100), inclined oil and water separator system (10) and vertically extending drainpipe (510).

35. The system according to claim 30, wherein the slug suppression and gas removal unit (100), the inclined oil and water separator system (10) and the vertically extending drainpipe (510) are arranged such that a liquid level (400) interaction between them is at a substantially equal height, thereby providing a liquid lock avoiding free gas carry under between the gas removal unit (100), inclined oil and water separator system (10) and vertically extending drainpipe (510).

36. The system according to claim 27, wherein
the oil and water separator system (10) comprises at least two inclined tubular oil and water separators (11a-11d) formed by an elongated outer tube (50) with an elongated inner tube (40) arranged therein, and
oil well substances are introduced into an end of the inner tube (40) via a feed section passing through the outer tube (50) and into the inner tube (40),
the inner tube (40) comprising multiple holes or slots (44) arranged in a longitudinal direction,
an interface (600) between oil and water in the respective inclined tubular oil and water separator (11a-11d) is located at a position approximately 50-70% of overall length (L) of the inclined tubular oil and water separator (11a-11d), the side of the interface defining an inlet end of the respective inclined tubular oil and water separator (11a-11d).

37. The system according to claim 36, wherein the location of the first hole or slots (44) toward the inlet end of the inclined tubular oil and water separator (11a-d) at least at the water side start at a position approximately ⅓ of the overall length (L) of the inclined tubular oil and water separator (11a-11d).
